(19) United States
(12) Patent Application Publication
(10) Pub. No.: US 2019/0128354 A1
(43) Pub. Date: May 2, 2019

(54) NON-ASBESTOS FRICTION MATERIAL

(71) Applicant: Keiji OJIMA, (US)

(72) Inventor: Keiji OJIMA, (US)

(21) Appl. No.: 16/094,064

(22) PCT Filed: Apr. 18, 2017
(86) PCT No.: PCT/JP2017/015513

§ 371 Date: Oct. 16, 2018

(30) Foreign Application Priority Data
Apr. 20, 2016 (JP) 2016-084647

(51) Int. Cl. F16D 69/02

(52) U.S. Cl. CPC F16D 69/026; F16D 69/028; F16D 2200/0043; F16D 2200/0052; F16D 2200/0065

(57) ABSTRACT

A non-asbestos friction material which comprises a fibrous base, a binder, a lubricating material, and an organic/inorganic filler, the friction material having a copper component content of 5 wt % or less with respect to the whole friction material composition and containing neither iron as an elemental metal nor any iron-based alloy. A carbon material which, in analysis by X-ray diffraction, has a (002)-planed value of 0.336-0.342 nm has been incorporated as at least some of the lubricating material in an amount of 2-6 wt % with respect to the whole friction material composition.

### TECHNICAL FIELD

The present invention relates to a non-asbestos friction material which is used, for example, in a disc brake for a vehicle, or the like.

### BACKGROUND ART

In recent years, in such a friction material, in order to suppress environment contamination of abrasion powders of the friction material, the content of a copper component that is said to be advantageous to the ensuring of breaking performance at the time of high-speed high-load braking tends to be regulated to be equal to or less than a certain degree. In this regard, for example, Patent Document 1 discloses a technique of ensuring braking performance at the time of high-speed high-load braking by predetermined amounts of ferrous sulfide particles and flaky graphite particles being contained as lubrication materials while the content of the copper component is suppressed to be equal to or less than a certain degree. In this technique, it is focused that the ferrous sulfide particles are decomposed into iron and sulfur under high-temperature environment, and it is aimed to cause adhesive friction between this iron component and an iron component of a counterpart member.

### CITATION LIST

### Patent Document

Patent Document 1: JP-A-2015-4037

### SUMMARY OF THE INVENTION

### Technical Problem

However, there is a concern that adhesive friction between iron components causes non-uniform abrasion in the friction material and the counterpart member, and there is a room for an improvement in ensuring of a stable friction coefficient.

An object of the present invention is to provide a non-asbestos friction material capable of suppressing degradation in abrasion resistance even at the time of high-speed high-load braking while suppressing a content of a copper component and capable of ensuring a stable and high friction coefficient.

### Solution to Problem

In order to solve the above-described problems, the invention described in claim 1 provides anon-asbestos friction material containing a fibrous base, a binder, a lubricating material, and an organic/inorganic filler, the friction material having a copper component content of 5 wt % or less with respect to the whole friction material composition and containing neither iron as an elemental metal nor any iron-based alloy. Further, a carbon material which, in analysis by X-ray diffraction, has a (002)-plane d value of 0.336 to 0.342 nm is incorporated as the lubricating material in an amount of 2 to 6 wt % with respect to the whole friction material composition.

The (002)-plane d value in analysis by X-ray diffraction is related to a graphitization degree in the carbon material. By setting the d value of the carbon material and the content of the carbon material with respect to the whole friction material composition in the above ranges, an appropriate lubrication action is obtainable even at the time of high-speed high-load braking. Further, for example, as compared with ferrous metal, the carbon material is less likely to abrade a counterpart member (such as a rotor), and non-uniform abrasion such as adhesive friction between iron components does not occur as well. Therefore, it is possible to ensure a stable and high friction coefficient while suppressing degradation in abrasion resistance.

### BRIEF DESCRIPTION OF THE DRAWINGS

FIG. 1 is a table showing compositions of raw materials of friction materials of Examples and Comparative Examples of a non-asbestos friction material according to the present embodiment and performance values thereof.

### DESCRIPTION OF EMBODIMENT

Hereinafter, embodiments of the present invention will be described in detail; however, the present invention is not limited to the following embodiments unless the present invention departs from the spirit thereof.

Hereinafter, an embodiment of a friction material according to the present invention will be described in detail. A non-asbestos friction material of the present embodiment contains a fibrous base, a binder, an organic filler, an inorganic filler, and a lubricating material.

Examples of a material which is used as the fibrous base include organic fibers such as aramid fibers, cellulose fibers, and acrylic fibers, and inorganic fibers such as glass fibers, rock wool, ceramics fibers, and wollastonite. These may be used alone or in combination of two or more kinds thereof. Particularly preferably, aramid fibers or rock wool can be exemplified. The content of the fibrous base is not particularly limited, but the fibrous base may be added in an amount of about 3 to 20 wt % with respect to the whole friction material composition.

The binder has a role of binding respective incorporated components of the friction material, and a known material can be used as the binder. Preferably, examples of the binder include a thermosetting resin such as a phenolic resin, a melamine resin, or an epoxy resin, and a modified product thereof. These may be used singly or in combination of two or more kinds thereof. Particularly preferably, a phenolic resin is exemplified. The content of the binder is not particularly limited, but the binder may be added in an amount of about 6 to 16 wt % with respect to the whole friction material composition.

The organic filler, the inorganic filler, and the lubricating material have a role of adjusting a friction coefficient of the friction material and friction performance such as abrasion.

Examples of the organic filler may include cashew dust and rubber dust. Examples of the inorganic filler may include potassium titanate, calcium hydroxide, calcium carbonate, calcium silicate, barium sulfate, iron oxide, zirconium silicate, zirconium oxide, and magnesium oxide.

Further, examples of the lubricating material may include tin sulfide, and a carbon material (carbon-based material) described later.

Incidentally, the friction material of the present embodiment contains neither an elemental metal such as copper or iron nor any alloy thereof. Copper may be contained in order to ensure lubricating property under high-temperature environment as long as the content thereof is 5 wt % or less with respect to the whole friction material composition.

In these days, with an increase in performance and output of automobiles, braking performance at the time of high-speed high-load braking, for example, abrasion resistance, and a stable and high friction coefficient under high-temperature environment are required. However, on the other hand, regarding the copper component that is said to be advantageous to the ensuring of such braking performance at the time of high-speed high-load braking, from environmental consciousness, the content thereof tends to be regulated to be equal to or less than a certain degree.

Meanwhile, the present inventors have conducted intensive studies, and as a result, have found that, by containing neither iron as an elemental metal nor any iron-based alloy and incorporating a carbon material which, in analysis by X-ray diffraction, has a (002)-plane d value of lattice plane (an average value of a plane interval) of 0.336 to 0.342 nm as the lubricating material in an amount of 2 to 6 wt % with respect to the whole friction material composition, it is possible to suppress degradation in abrasion resistance even at the time of high-speed high-load braking while suppressing a content of a copper component and to ensure a stable and high friction coefficient.

In the present embodiment, as the carbon material, a carbon material made of graphite having a (002)-plane d value in a range of 0.336 to 0.342 nm, such as expanded graphite, is employed. Incidentally, the d value indicates a (002)-plane interval and is related to a graphitization degree. When the d value is converted into Franklin's p value, the d value is equivalent to 5.994 to 73.586%. When these d value and p value are too high, the lubrication action becomes excessive, and thus this leads to insufficiency of braking performance (efficacy (friction coefficient)). On the other hand, when these d value and p value are too low, abrasion of the friction material is increased, that is, this leads to degradation in abrasion resistance. The present inventors have found the d value of the carbon material and the content thereof by which those values are compatible with each other. Incidentally, although described later in Examples, a more preferable value of the upper limit of the d value is 0.341 nm. In addition, a more preferable value of the content of the carbon material is 2 to 4 wt %.

Further, the friction material of the present embodiment contains neither iron as an elemental metal nor any iron-based alloy. For example, the friction material of the present embodiment does not contain iron sulfide easily generating an iron component through pyrolysis as described in the aforementioned Patent Document 1. In the present embodiment, a disc rotor made of ferrous metal is used as the counterpart material to the friction material, the carbon material in the friction material is less likely to abrade the counterpart material as compared with iron, and non-uniform abrasion caused by adhesive friction between iron components is hard to generate as well.

Further, in the present embodiment, a thermally-expanded carbon material such as expanded graphite described above is used. Since crystallites are randomly oriented by thermal expansion, excessive lubrication is hard to generate due to friction between crystallite end planes. Incidentally, examples of a method for performing thermal expansion include a method of intercalating an expandable substance containing an acid such as sulfuric acid into graphite and a method in which processing is stopped at the stage of graphite being in a thermal expansion state in the course of a step of graphitizing specific coke.

Further, in the present embodiment, a size La of crystallite of the carbon material in the a-axis direction and a size Lc of crystallite of the carbon material in the c-axis direction in analysis by X-ray diffraction are set to 50 to 80 nm, respectively. When values of these La and Lc are too large, randomness of orientation of crystallites are hard to obtain, and thus this may lead to insufficiency of braking performance. On the other hand, when the values thereof are too small, the lubricating property becomes excessive, and thus this may lead to a decrease in friction coefficient at the time of high-speed high-load braking. By employing the above values, such inconveniences can be prevented from being generated. That is, randomness of crystallites is improved, and a stable and high friction coefficient is more easily ensured. Incidentally, more preferable values of these La and Lc are 50 to 70 nm.

The friction material of the present invention can be applied, for example, to a disk brake pad for a vehicle or the like. In addition, although not limited thereto, the friction material of the present invention can be applied to a conventionally known friction material such as a brake shoe for drum brake.

### EXAMPLES

Hereinafter, the present invention will be described in detail by means of Examples. However, the present invention is not limited thereto.

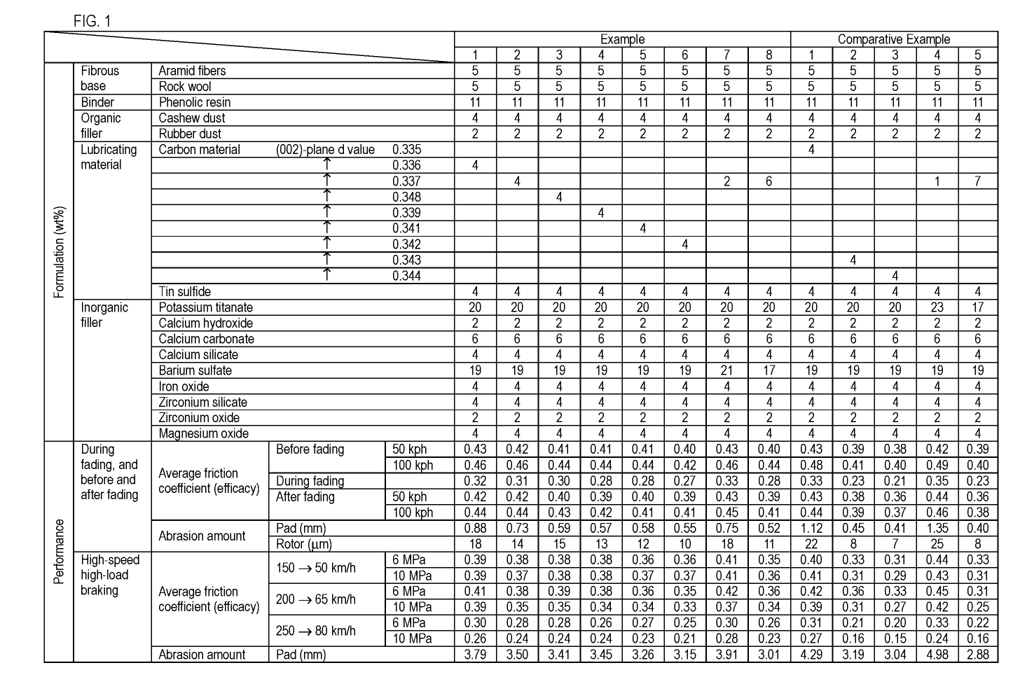

In this Example, raw materials of a friction material were blended according to the content shown in FIG. 1 to obtain friction material compositions of Examples 1 to 8 and Comparative Examples 1 to 5. Then, the friction material compositions were mixed, pressured, heated, and cured as described above. Incidentally, the unit of the content of each raw material of the friction material in the table is wt % with respect to the whole friction material composition.

The produced friction materials of Examples 1 to 8 and

Comparative Examples 1 to 5 were subjected to the following measurement, and the results thereof were shown in FIG. 1.

That is, according to JASO C406, an average friction coefficient (efficacy) at an initial speed of 50 km/h and 100 km/h of a second efficacy test (before fading and after fading) and a minimum friction coefficient (efficacy) at a first fading were measured, and after a series of the measurement, abrasion amounts of a pad and a rotor were measured. In addition, an average friction coefficient (efficacy) in high-speed high-load braking was measured. A plurality of predetermined braking liquid pressure (liquid pressure for pressing the pad to the rotor) values were respectively measured with three deceleration patterns of deceleration from an initial speed of 150 km/h to 50 km/h, deceleration from an initial speed of 200 km/h to 65 km/h, and deceleration from an initial speed of 250 km/h to 80 km/h. Then, after a series of the measurement, the abrasion amount of the pad was measured. Incidentally, regarding the average friction coefficient (efficacy) in high-speed high-load braking, a case where the braking liquid pressure value is 6 MPa and a case where the braking liquid pressure value is 10 MPa in respective deceleration patterns were described in FIG. 1.

As shown in FIG. 1, in Examples 1 to 8 of the present invention, favorable results in the average friction coefficient (efficacy) and the abrasion amount were obtained in all cases. According to this, it was found that a friction material excellent in an average friction coefficient (efficacy) and an abrasion amount even before and after the aforementioned fading but also in high-speed high-load braking is obtainable by containing neither iron as an elemental metal nor any iron-based alloy and containing a carbon material which, in analysis by X-ray diffraction, has a (002)-plane d value of 0.336 to 0.342 nm being incorporated as the lubricating material in an amount of 2 to 6 wt % with respect to the whole friction material composition. On the other hand, since, in Comparative Examples 1 to 5 having a different d value and a different content of the carbon material from the above-described d value and the content of the carbon material, the average friction coefficient (efficacy) or the abrasion amount was inferior, it was found that the average friction coefficient (efficacy) and the abrasion amount confirmed in Examples of the present invention were obtained by the d value and the content of the carbon material described above.

As described above, according to the present invention, an appropriate lubrication action is obtainable even at the time of high-speed high-load braking. In addition, non-uniform abrasion such as adhesive friction between iron components does not occur, and thus, in the friction material, it is possible to ensure a stable and high friction coefficient while suppressing degradation in abrasion resistance.

Incidentally, as understood from the results of FIG. 1, a more preferable value of the upper limit of the (002)-plane d value is 0.341 nm (see Examples 1 to 5). In addition, a more preferable value of the content of the carbon material is 2 to 4 wt % (see Examples 1 to 7). By setting these more preferable values, the effect of the present invention can be made further preferable.

### INDUSTRIAL APPLICABILITY

The friction material of the present invention can be applied to a product such as a disk brake pad or a brake shoe for a vehicle or the like which requires a conventionally known friction material.

1. (canceled)

2. A non-asbestos friction material comprising a fibrous base, a binder, a lubricating material, and an organic/inorganic filler, the friction material having a copper component content of 5 wt % or less with respect to the whole friction material composition and containing neither iron as an elemental metal nor any iron-based alloy, a carbon material which, in analysis by X-ray diffraction, has a (002)-plane d value of 0.336 to 0.342 nm being incorporated as the lubricating material in an amount of 2 to 6 wt % with respect to the whole friction material composition, sizes (La and Lc) of crystal particles of the carbon material being 50 to 70 nm.
